(19) United States
(12) Patent Application Publication
(10) Pub. No.: US 2004/0090422 A1
(43) Pub. Date: May 13, 2004

(54) Keyboard

(76) Inventor: Wen-Fu Tsai, Chung-Ho City (TW)

Correspondence Address: SHOEMAKER AND MATTARE, LTD, P.O. BOX 2286, 2001 JEFFERSON DAVIS HIGHWAY, ARLINGTON, VA, 22202-0286, US

(21) Appl. No.: 10/703,591

(22) Filed: Nov. 10, 2003

(30) Foreign Application Priority Data
Nov. 12, 2002 (TW) 091218099

(51) Int. Cl. G09G 5/00

(52) U.S. Cl. 345/168

(57) ABSTRACT

A keyboard having a plurality of alphabetical keys and number keys is proposed. The alphabetical keys are divided into a first key combination and a second key combination, and the number keys are located between the first and second key combinations. The number keys are adjacent to a plurality of cursor shifting keys. The number keys are arranged in columns, and the cursor shifting keys are arranged in rows below the number keys. The cursor shifting keys are positioned at a lower elevation than the number keys so as to avoid hitting the wrong keys by mistake during user's key-in operation. The number keys further include an Enter key, while a Backspace key and a Tab key are adjacent to the number keys to reduce hand-moving range for the user, so as improve key-in speed and satisfy ergonomic criteria.

### BACKGROUND OF THE INVENTION

1. Field of the Invention

The present invention relates to keyboards, and more particularly, to a keyboard comprising a plurality of alphabetical keys and a plurality of number keys, wherein the plurality of number keys are located at the center of the plurality of alphabetical keys.

2. Description of the Related Art

FIG. 1 illustrates a keyboard 1 commonly used by a personal computer (PC). The keyboard 1 has a plurality of number keys 11 and 13, a plurality of alphabetical keys 10, a plurality of cursor shifting keys 12, a Back Space key 14, a Enter key 15, a plurality of function keys 16, a Tab key 17. Since functions of these keys are well-known standard key functions for the common computer keyboard, they are not further described in detail below.

Referring to FIG. 1, the conventional keyboard 1 has the plurality of alphabetical keys 10 installed on a left side of the keyboard 1, and the plurality of cursor shifting keys 12 and the plurality of number keys 11 and 13 are installed on right side of the keyboard 1. When the user executes a cursor shifting operation during a key-in operation, he/she needs to move his/her right hand fingers from the alphabetical keys 11 to the cursor shifting keys 12 on the right side of the keyboard. Since the moving range for the right hand increases, the speed for key-in operation is reduced. Also, a mouse (not shown) is generally disposed on the left side relative to the keyboard 1, so the current key arrangement for the keyboard results not only switching right hand at a high frequency but also increase the right hand moving range, making it impossible to enable balanced movements from both left and right hands of the user. In other word, the keyboard is designed as one that is more suitable for a right-handed user to operate. With such key arrangement, it is easy for the user of the keyboard 1 to tilt his/her body during the key-in operation, leading to a wrong posture for the user. Thus, the currently available keyboard often does not satisfy the human engineering criteria and causes tiredness and soreness for the user's neck, shoulders, and hands easily.

Therefore, the problems associated with the currently available keyboard are resolved by providing a keyboard that enables balanced operations from both left and right hands of the user, so as to reduce the hand moving range as well as tiredness and soreness for the user's neck, shoulders, and hands.

### SUMMARY OF THE INVENTION

In light of the drawbacks above, the present invention provides a keyboard to resolve the problems associated with the conventional keyboard. The primary objective of the present invention is to provide a keyboard that reduces a hand-moving range for the user to improve a key-in speed.

Another objective of the present invention is to provide a keyboard without tilting position of the user. The keyboard allows balanced key-in operations from both left and right hands so as to satisfy human engineering criteria.

A further objective of the present invention is to provide a keyboard universal to both left-handed and right-handed users.

In accordance with the above and other objectives, the present invention proposes a keyboard, which comprises a plurality of alphabetical keys and a plurality of number keys. The alphabetical keys are divided into a first key combination and a second key combination, and the number keys are installed between the first key combination and the second key combination in order to reduce complexity for hand movement.

The number keys are installed adjacent to a plurality of cursor shifting keys in such a way that the number keys are arranged vertically and the cursor shifting keys are arranged horizontally across below the number keys. And the cursor shifting keys are installed such that a height for the cursor shifting keys is lower than a height for the number keys to prevent hitting the wrong keys by mistake during key-in operation of the user.

Also, the number keys are installed adjacent to a Back Space key and a Tab key, so as to further reduce hand moving range for both left and right hands of the user effectively.

To provide a further understanding of the invention, the following detailed description illustrates embodiments and examples of the invention, it is to be understood that this detailed description is being provided only for illustration of the invention and not as limiting the scope of this invention.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a top view illustrating a key arrangement for a conventional keyboard;

FIG. 2 is a top view illustrating a key arrangement for a keyboard according to the first embodiment;

FIG. 3A is a schematic diagram illustrating a key-in operation using the keyboard according to the first embodiment of the present invention;

FIG. 3B is a schematic diagram illustrating the key-in operation using the conventional keyboard illustrated in FIG. 1;

FIGS. 4A through to 4J are cross-sectional views illustrating arrangement of the number key combination and cursor shifting key combination according to the first embodiment of the present invention;

FIG. 5 is a top view illustrating the key arrangement of the keyboard according to a second embodiment of the present invention; and

FIG. 6 is a top view illustrating the key arrangement of the keyboard according to a third embodiment of the present invention.

### DETAILED DESCRIPTION OF THE EMBODIMENTS

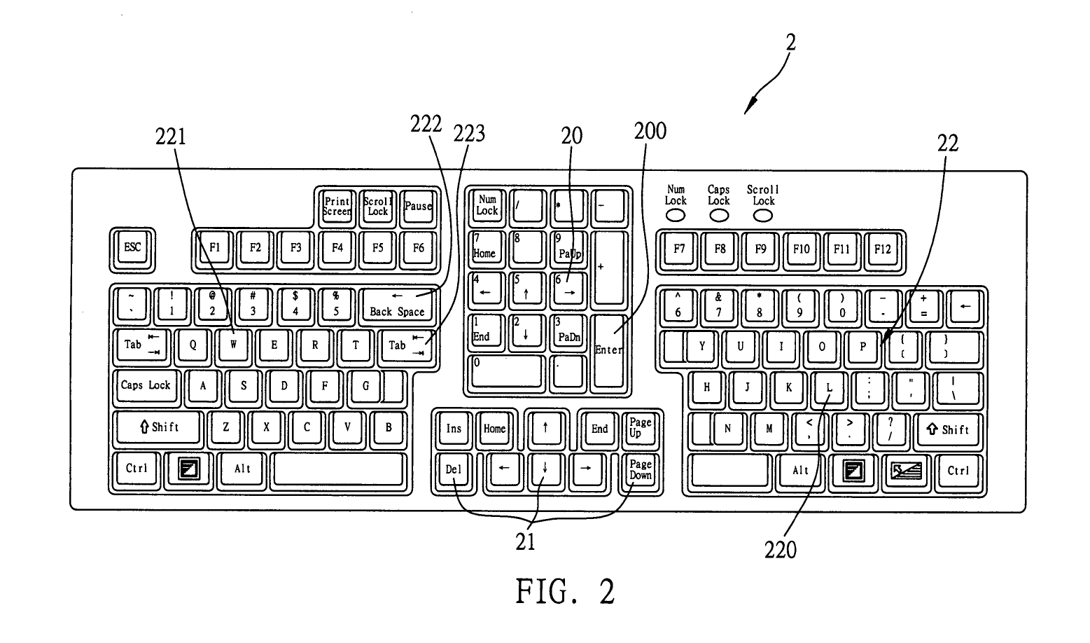

FIG. 2 is an elevation view illustrating an arrangement of keys in a keyboard 2 according to a first embodiment of the invention. Referring to FIG. 2, the key board 2 comprises at least a number key combination 20, a cursor shifting key combination 21, and an alphabetical key combination 22. It is noted here that the keyboard 2 also comprises other keys, such as a Function key, a Ctrl key, and a Shift key. However, the following description is only made with reference to keys related to the present invention.

The alphabetical key combination 22 is divided into a right key arrangement zone 220 and a left key arrangement zone 221, and the number key combination 20 and the cursor shifting key combination 21 are installed between the right and left key arrangement zones 220 and 221.

The left key arrangement zone 221 further comprises a Back Space key 222 and Tab key 223. The Back Space key 222 and the Tab key 223 are installed adjacent to the number key combination 20. The number key combination 20 further includes an Enter key 200, making it redundant to additionally install the Enter key 200 in the alphabetical key combination 22.

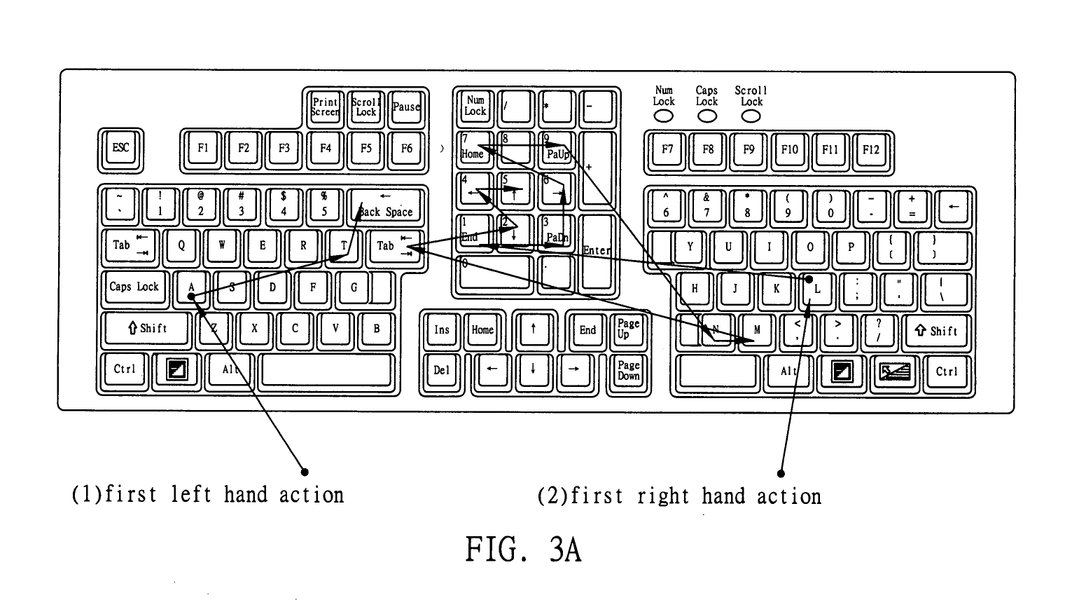

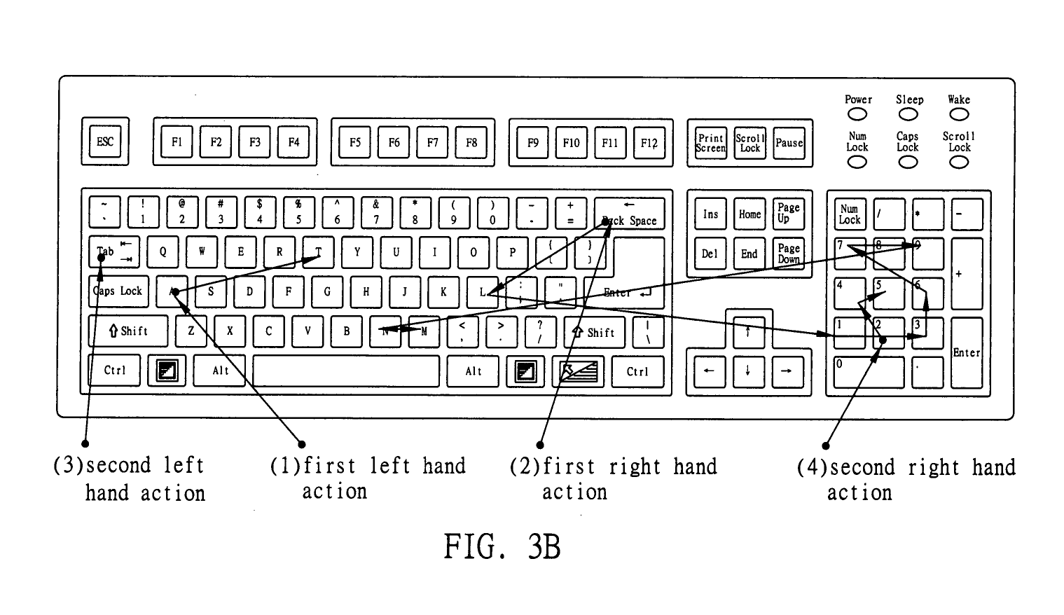

When the user keys in a string of data, such as AL13679MN245 using the keyboard 2 during a data key-in process, the user is required to perform the following key-in operations as shown in FIG. 3A if he/she keys in an alphabet T for the alphabet L by mistake (i.e. key-in error). The key-in operations involve depressing the alphabetical keys A and T by the left hand. Next, as the user found the alphabet L is not keyed in correctly, the Back Space key 222 is depressed by the left hand to delete the wrong alphabet for L. The correct alphabet L is then keyed in by the right hand. The right hand is shifted to the number key combination 20 to key in the numbers 1, 3, 6, 7, and 9 in sequence. Still, the right hand is used to depress the alphabetical keys M and N before depressing the Tab key 223. After that, the right hand is shifted to number key combination 20 to key in the numbers 2, 4, and 5 in sequence.

On the other hand, as the user keys in the above-mentioned data (AL13679MN245) using the conventional keyboard and the same errors are made during the key-in process, the entire key-in operation is performed as illustrated in FIG. 3B. First of all, the key-in operation involves depressing the alphabetical keys A and T by the left hand. Next, as the user finds the alphabet for L is not keyed in correctly, the user depresses the Back Space key 14 with the right hand to delete the wrong alphabet L. Then, the alphabet L is keyed in by the right hand before the right hand is moved in a great extent to the number keys 13 for keying in numbers 1, 3, 6, 7, and 9 in sequence. The user moves his/her right hand in a great extent to depress the alphabetical keys N and M. The user switches to his/her left hand to depress the Tab key 17. After that, the user switches to his/her right hand again to move in a great extent to the right so as to depress the number keys 13 for keying in the numbers 2, 4, and 5.

It is understood from the above that the number key combination 20 and the cursor shifting key combination 21 are installed at the center of the alphabetical key combination 20 in the keyboard 2 of the present invention, to thereby reduce hand moving range and complexity for hand movement. Therefore, while the conventional keyboard is used to perform the key-in operation above, four hand-switching actions are required. However, the number of hand switching actions is reduced down to twice if the keyboard of the invention is used instead. Furthermore, the Back Space key 222 and the Tab key 223 are installed adjacent to the number key combination 20 to simplify the complexity for hand movement of the user.

Since the number key combination 20 and the cursor shifting key combination 21 are installed at the center of the alphabetical key combination 22 in the keyboard of the present invention, the right key arrangement zone 220 and the left key arrangement zone 221 divided from the alphabetical key combination 22 form symmetrical zones in order to produce a synchronized visual effect for the user.

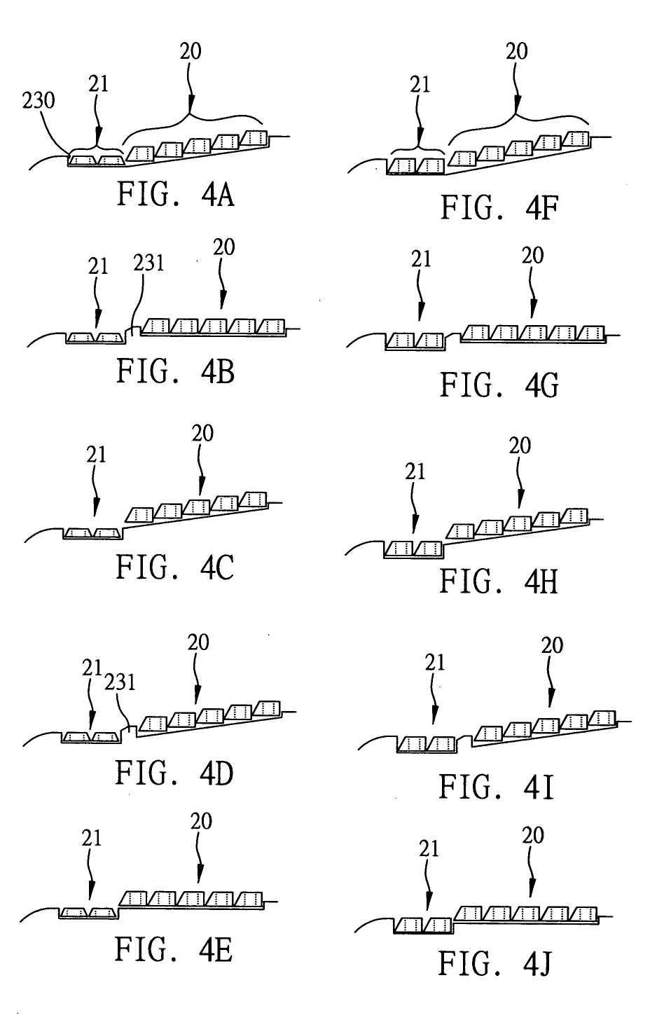

Also, the number key combination 20 includes an Enter key 22 to substitute for the Enter key 15 from the alphabetical keys 10 of the conventional keyboard 1, so only one single Enter key is required in the keyboard of the present invention to save the keyboard space. Thus, the keyboard of the present invention is different from the conventional keyboard 1 having one Enter key installed in the alphabetical combination, and another Enter key installed in the number key combination. FIGS. 4A through to 4J are cross-sectional views illustrating 10 types of arrangements for number key combination 20 and the cursor shifting key combination 21 shown in FIG. 2. In the first embodiment, the cursor shifting key combination 21 is installed below the number key combination 20. And the number key combination 20 is arranged in an elevated manner, a stepped-up manner, or an up-and-down key combination with respect to the cursor shifting key combination 21 such that the number key combination 20 has a height difference from the cursor shifting key combination 21. As a result, this prevents hitting the keys in the wrong rows by mistake when the key-in operation is performed with a longer keyboard.

As shown in FIGS. 4A through to 4E, keys from the cursor shifting key combination 20 are positioned at a lower elevation than keys from the number key combination 21, and key accommodating grooves 230 have a depth equivalent to a height for the cursor shifting key combination 21. Moreover, as shown in FIGS. 4A and 4D, a protruding piece 231 is formed between the cursor shifting key combination 21 and the number key combination 20 to prevent hitting the wrong keys by mistake more effectively.

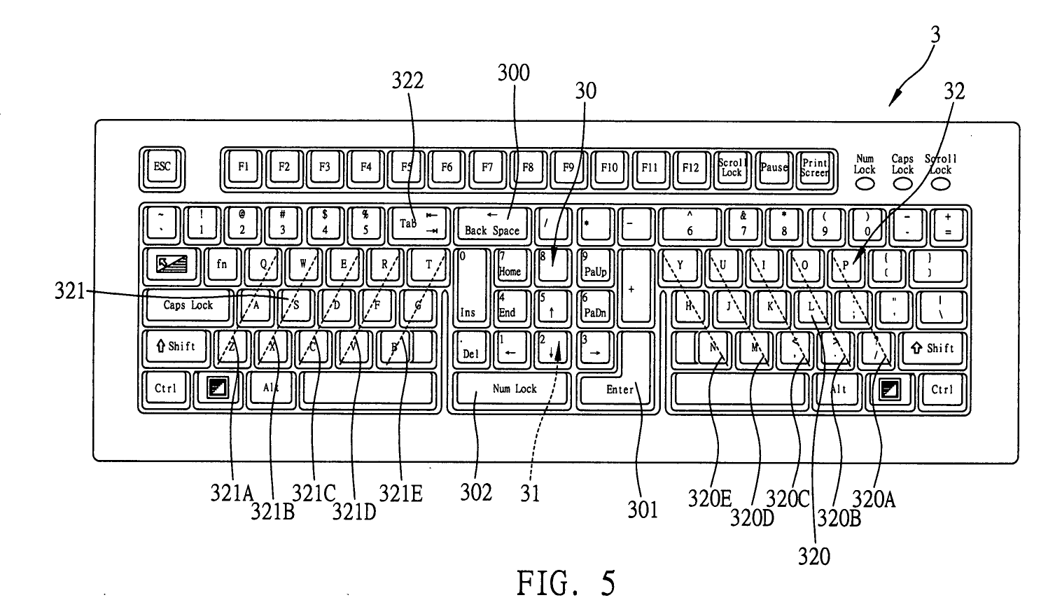

FIG. 5 is an elevation view illustrating the keyboard arrangement according to the second embodiment of the present invention. As shown in FIG. 5, the key board 3 of the present embodiment differs from the keyboard 1 of the first embodiment in that function of the cursor shifting key combination 21 is integrated into the number key combination 20, and a Num Lock key 302 is installed below the number key combination 20. Therefore, by depressing the Num Lock key 302 directly with a thumb, the user can quickly switch the function of the number key 31 into either cursor shifting or keying in number. Thus, with the key arrangement for the keyboard 3 of the present embodiment, the range for moving the user's elbow is reduced. Also, the keyboard 3 of the present embodiment includes only single set of the Back Space key 300, the Tab key 322, and the Enter key 301 arranged at the center of the keyboard 3, making it more space economical than the keyboard 2 of the first embodiment.

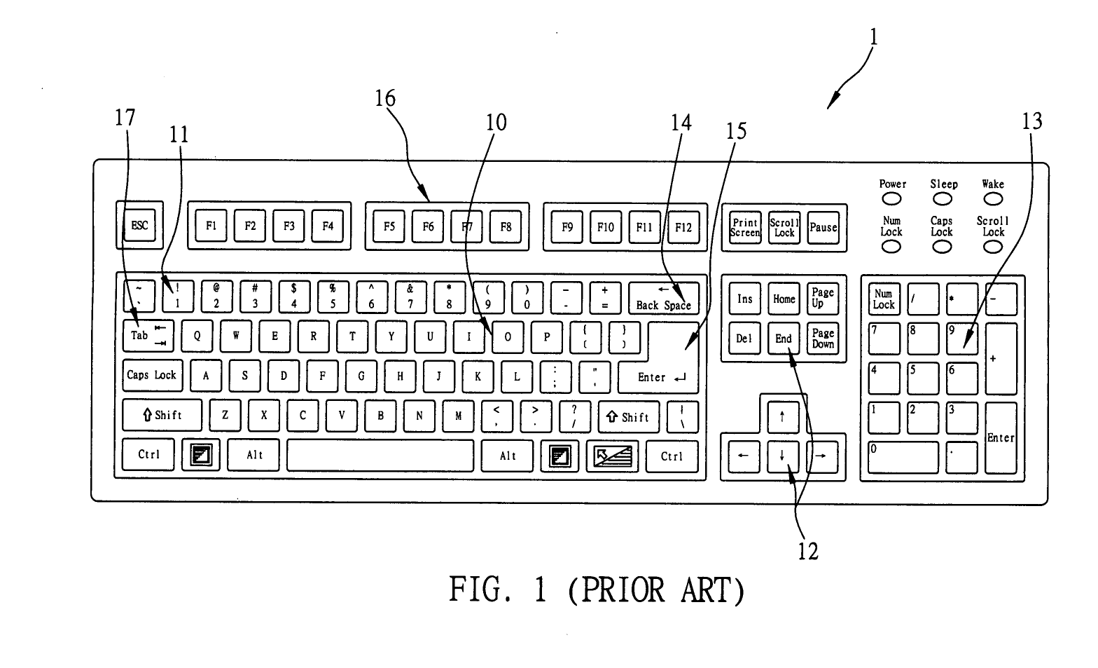

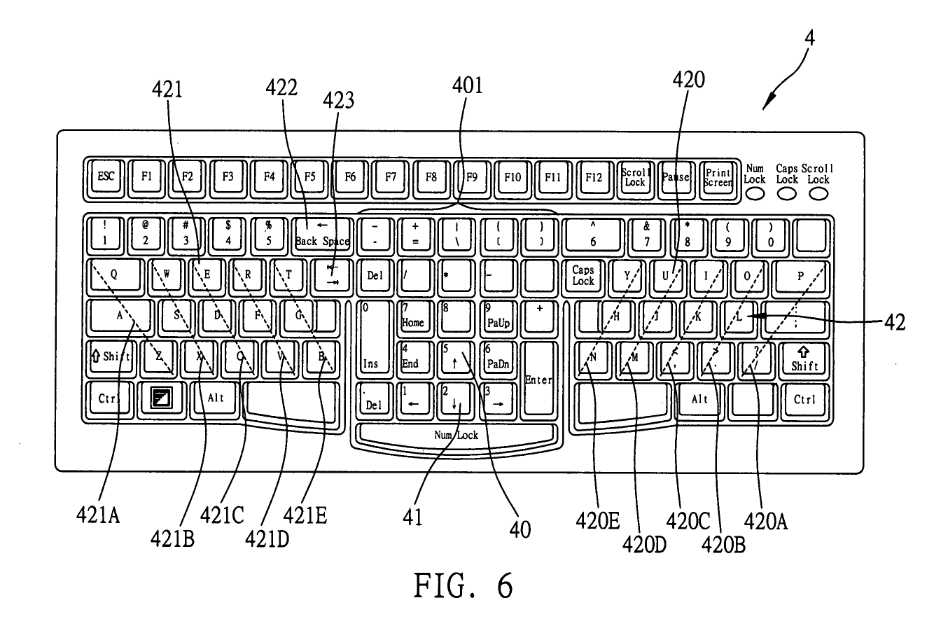

The alphabetical keys from the right key arrangement zone 320 are arranged in rows to slant progressively to left, and the alphabetical keys from the left key arrangement zone 321 are arranged in rows to slant progressively to right so as to agree with a natural hand posture and directions in which the fingers extend and flex. Therefore, when the user performs the key-in operation, he/she can place his/her fingers according to the natural hand posture on the keyboard. As shown in the left key arrangement zone 321 in FIG. 5, the keys marked by left slanted dotted line 321A are operated by little finger from left hand (not shown), the keys marked by left slanted dotted line 321B are operated by ring finger of left hand (not shown), the keys marked by left slanted dotted line 321C are operated by middle finger of left hand, the keys marked by left slanted dotted lines 321D and 321E are operated by forefinger of left hand. As for the right key arrangement zone 320 in FIG. 5, the keys marked by right slanted dotted line 320A are operated by little finger from right hand (not shown), the keys marked by right slanted dotted line 320B are operated by ring finger of right hand (not shown), the keys marked by right slanted dotted line 320C are operated by middle finger of right hand, the keys marked by right slanted dotted lines 320D and 320E are operated by forefinger of right hand. Since the key-in operation described above does not require moving the user's elbow outwards or rotating the user's fingers, the key-in operation using the keyboard 5 of the present embodiment can better satisfy the human engineering criteria as compared with the conventional keyboard 1 shown in FIG. 1. FIG. 6 is a top view illustrating the key arrangement of the keyboard according to a third embodiment of the present invention. As shown in FIG. 6, the keyboard 4 of the present embodiment differs from the keyboard 3 of the second embodiment in that a few symbol keys 401 are installed above the number key combination 40 instead of installing in the alphabetical key combination (on right side of the right key arrangement zone 320 in the keyboard 3 shown in FIG. 5) so as to reduce the width of the keyboard 4. The Backspace key 422 and the Tab key 423 are installed adjacent to the number key combination 40. As the keyboard width is reduced and the Back Space key 422, the Tab key 423 are installed adjacent to the number key combination 40, the user's hand movement is simplified with his/her hand moving range being reduced, so as to speed up the key-in operation more efficiently.

Furthermore, upper row alphabetical keys in the right key arrangement zone 420 slant to right with respect to lower row alphabetical keys in the right key arrangement zone 420, and the upper row alphabetical keys in the left key arrangement zone 421 slant to left with respect to the lower row alphabetical keys in the right key arrangement zone 421. Therefore, when the user keys in alphabets using the keyboard 4 of the present embodiment, balanced key-in operations are performed by user's left and right hand fingers. As shown in FIG. 6, in the left key arrangement zone 421, the keys marked by left slanted dotted line 421A are operated by little finger from left hand (not shown), the keys marked by left slanted dotted line 421B are operated by ring finger of left hand (not shown), the keys marked by left slanted dotted line 421C are operated by middle finger of left hand, the keys marked by left slanted dotted lines 421D and 421E are operated by forefinger of left hand. As for the right key arrangement zone 420 in FIG. 6, the keys marked by right slanted dotted line 420A are operated by little finger from right hand (not shown), the keys marked by right slanted dotted line 420B are operated by ring finger of right hand (not shown), the keys marked by right slanted dotted line 420C are operated by middle finger of right hand, the keys marked by right slanted dotted lines 420D and 420E are operated by forefinger of right hand. According to the present embodiment, the keyboard 4 provides a more balanced coordination for key-in operation using both hands as compared to the conventional keyboard 1 having the alphabetical keys 10 entirely arranged in rows slanting to left.

The embodiments provided above are clearly for description purposes and shall not be used to limit the actual scope of the present invention. For example, the keys in the alphabetical key combination and number key combination are not limited to those described in the embodiments, other key arrangements including the number keys and cursor shifting keys installed in between the alphabetical key arrangements may also fall in the scope of the present invention. And apart from English alphabets, the alphabet keys may denote other character symbols such as Japanese and Chinese phonetic transcriptions or symbols (for example, phonetic notations or Big5 codes). Also, depending on actual examples, the key arrangements illustrated in FIGS. 4A through to 4J are applicable to keys other than keys in the number key combination and cursor key combination.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A keyboard comprising a plurality of alphabetical keys and a plurality of number keys, wherein the alphabetical keys are divided into a first key combination and a second key combination, and the number keys are located between the first and second key combinations.

2. The keyboard of claim 1, wherein the number keys are adjacent to a plurality of cursor shifting keys.

3. A keyboard comprising a plurality of number keys located adjacent to a Backspace key and a Tab key.

4. The keyboard of claim 3, wherein the number keys are adjacent to a plurality of cursor shifting keys.

5. The keyboard of claim 2, wherein the number keys are arranged in columns, and the cursor shifting keys are arranged in rows below the number keys and positioned at a lower elevation than the number keys.

6. The keyboard of claim 4, wherein the number keys are arranged in columns, and the cursor shifting keys are arranged in rows below the number keys and positioned at a lower elevation than the number keys.

7. The keyboard of claim 5, wherein the cursor shifting keys have a height equivalent to a depth of a key accommodating groove of the keyboard for receiving the cursor shifting keys.

8. The keyboard of claim 2, wherein a protrusion piece is formed between the cursor shifting keys and the number keys.

9. The keyboard of claim 4, wherein a protrusion piece is formed between the cursor shifting keys and the number keys.

10. The keyboard of claim 2, wherein the number keys are arranged below the cursor shifting keys.

11. The keyboard of claim 4, wherein the cursor shifting keys are arranged in columns, and the number keys are arranged in rows below the cursor shifting keys and positioned at a lower elevation than the cursor shifting keys.

12. The keyboard of claim 1, wherein the alphabetical keys are arranged in rows, and the alphabetical keys in an upper row are aligned to the left or right of the corresponding alphabetical keys in a lower row among the rows of each of the first and second key combinations.

13. The keyboard of claim 1, wherein the first key combination is located at the left of the number keys, and the second key combination is located at the right of the number keys, and wherein the alphabetical keys are arranged in rows, such that the alphabetical keys in an upper row are aligned to the right of the corresponding alphabetical keys in a lower row among the rows of the first key combination, and the alphabetical keys in an upper row are aligned to the left of the corresponding alphabetical keys in a lower row among the rows of the second key combination.

14. The keyboard of claim 1, wherein the plurality of number keys further comprise an Enter key, and the plurality of alphabetical keys further comprise a Backspace key and a Tab key, the Backspace key and the Tab key located adjacent to the plurality of number keys.

15. The keyboard of claim 14, wherein the Enter key, the Backspace key, and Tab key are adjacent to the plurality of number keys.

16. The keyboard of claim 1, wherein the plurality of number keys further comprise number keys for shifting a cursor and switching keys for switching the cursor shifting number keys between the use for inputting numbers and the use for shifting the cursor.

17. The keyboard of claim 3, wherein the plurality of number keys further comprise number keys for shifting a cursor and switching keys for switching the cursor shifting number keys between the use for inputting numbers and the use for shifting the cursor

18. A keyboard comprising a plurality of alphabetical keys, which are divided into a first key combination and a second key combination, such that the first key combination is operable for a left hand of a user and the second key combination is operable for a right hand of the user, the plurality of alphabetical keys arranged in rows.

19. The keyboard of claim 18, wherein the alphabetical keys in an upper row are aligned to the right of the corresponding alphabetical keys in a lower row among the rows of the first key combination, and the alphabetical keys in an upper row are aligned to the left of the corresponding alphabetical keys in a lower row among the rows of the second key combination.

20. The keyboard of claim 18, wherein the alphabetical keys in an upper row are aligned to the left of the corresponding alphabetical keys in a lower row among the rows of the first key combination, and the alphabetical keys in an upper row are aligned to the right of the corresponding alphabetical keys in a lower row among the rows of the second key combination.
